(19) United States
(12) Patent Application Publication
(10) Pub. No.: US 2016/0203510 A1
(43) Pub. Date: Jul. 14, 2016

(54) ACTIVITY AND CONTENT DISCOVERY FOR PERSONALIZED CAMPAIGNS IN AN ENTERPRISE SOCIAL CONTEXT

(71) Applicant: Microsoft Technology Licensing, LLC., Redmond, WA (US)

(72) Inventors: Tiago Pregueiro, Oslo (NO); Lucian Baciu, Oslo (NO); Sverre Tennøe, Oslo (NO); Rune Devik, Fosslandsosen (NO); Bjørnstein Lilleby, Tromso (NO); Erlend Jensen, Tromso (NO); Stein Arild Jakobsen, Tromso (NO); Oleg Melnychuk, Oslo (NO)

(73) Assignee: MICROSOFT TECHNOLOGY LICENSING, LLC., Redmond, WA (US)

(21) Appl. No.: 14/593,650

(22) Filed: Jan. 9, 2015

(51) Int. Cl. G06Q 30/02; G06Q 50/00

(52) U.S. Cl. CPC G06Q 30/0255; G06Q 30/0246; G06Q 50/01

(57) ABSTRACT

A personalized campaign engine is provided. The personalized campaign engine selects a user as a candidate receiver of a campaign message. A personalized campaign message is generated for the user that comprises content items that are relevant to the user based on identified relationships between the user and content items and relationships between the user and other individuals. Relationships between the user and content items and relationships between the user and other individuals are identified by interrogating disparate repositories of information for organizational relationship data and activity data associated with the user. The personalized campaign engine customizes the campaign message for the user by using known information about the user to select a certain template, medium, and delivery strategy. Aspects of the personalized campaign system discover and provide relevant content to users, and therefore, increase user efficiency by enabling users to spend less time searching for content that they need.

### BACKGROUND

A variety of web-based social products are available to users; however, many social products oftentimes fail to re-engage existing users or drive adoption for new users due to various reasons, such as because of a lack of personalized communications with users. Impersonalized campaigns treat all users with a same campaign; however, not all users have the same motivation for using a specific product. It is with respect to these and other considerations that examples have been made.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects of the present disclosure are directed to generating a personalized and relevant campaign for a user. Aspects of the personalized campaign system select a user as a candidate receiver of a campaign message. According to an aspect of the campaign, a campaign message is generated and provided to the user that comprises content items that are relevant to the user based on identified relationships between the user and content items and relationships between the user and other individuals. Relationships between the user and content items and relationships between the user and other individuals are identified by interrogating disparate repositories of information (e.g., social networking services, enterprise social network services, productivity software application services, collaborative services, communication application services, etc.) for organizational relationship data and activity data associated with the user. According to an aspect, the campaign message includes content that is relevant to the user. For example, the campaign message includes content that is trending around the user. According to another example, the campaign message includes content that the user is not aware of the existence of, but that is relevant to the user. According to another example, the campaign message includes content that is relevant to the user, but the location of which is not known by the user.

Aspects of the personalized campaign system discover and provide relevant content to users, and therefore, increase user efficiency by enabling users to spend less time searching for content that they need. Additionally, users are able to skip steps that they would normally have to go through to find content for which they are searching, and thus, aspects of the personalized campaign system reduce network bandwidth.

Examples may be implemented as a computer process, a computing system, or as an article of manufacture such as a computer program product or computer readable media. The computer program product may be a computer storage media readable by a computer system and encoding a computer program of instructions for executing a computer process. The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention. In the drawings:

FIG. 1 is a simplified block diagram of one example of a personalized campaign system;

FIG. 2 is a simplified block diagram illustrating a process performed by a user selection module for determining of a list of targeted users for a campaign;

FIG. 3 is an illustration of an example process of how a content item is selected to become a piece of recommended content to be included in a campaign;

FIG. 4A is an illustration of an example campaign message embodied as an email;

FIG. 4B is an illustration of an example campaign message embodied as an MMS message;

FIG. 5 is a flow chart of an example method for providing a personalized and relevant campaign;

FIG. 6 is a block diagram illustrating example physical components of a computing device with which aspects of the invention may be practiced;

FIGS. 7A and 7B are simplified block diagrams of a mobile computing device with which aspects of the present invention may be practiced; and

FIG. 8 is a simplified block diagram of a distributed computing system in which aspects of the present invention may be practiced.

### DETAILED DESCRIPTION

The following detailed description refers to the accompanying drawings. Wherever possible, the same reference numbers are used in the drawings and the following description to refer to the same or similar elements. While aspects of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims. Examples may take the form of a hardware implementation, or an entirely software implementation, or an implementation combining software and hardware aspects. The following detailed description is, therefore, not to be taken in a limiting sense.

Aspects of a personalized campaign system optimize a likelihood of a user who receives a campaign message to re-engage with a product associated with the campaign message, for example, a tool for surfacing personalized content to the user from across various workloads based on what the user is working on and what is trending around the user. Aspects of the personalized campaign system allow for a personalized campaign engine to generate a list of candidate users based on various criteria, generate and construct a campaign message including content relevant to a candidate user, determine a delivery strategy (e.g., schedule, medium, etc.) for the campaign message, schedule implementation of the campaign based on the determined delivery strategy, and dispatch the campaign message to the candidate user according to the delivery strategy.

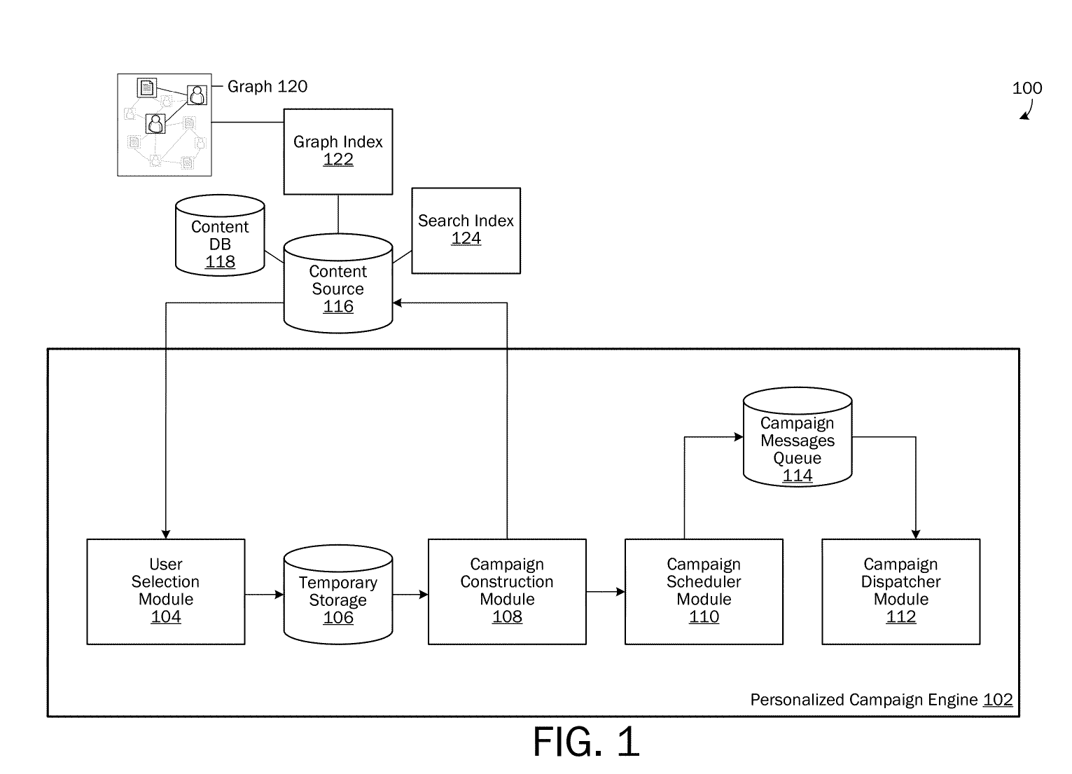

FIG. 1 is a simplified block diagram of one example of a personalized campaign system 100. According to an aspect, components of the personalized campaign system 100 operate as a distributed system, where each component is accessed via a suitable network. According to another aspect, various components of the system operate together as an integrated system. As illustrated, the personalized campaign system 100 includes a personalized campaign engine 102. The personalized campaign engine 102 comprises a user selection module 104 operable to determine which users to target for a personalized and relevant campaign. The user selection module 104 generates a list of candidate users based on various criteria. According to an aspect, the user selection module 104 is operable to query a plurality of content sources 116 for various criteria, which are used by the user selection module 104 to determine if a given user has unconsumed content available to him/her, and if the given user is likely to respond or interact with the campaign. According to another aspect, the user selection module 104 is operable to receive information from various content sources 116 in a push scheme based on a predetermined schedule or on demand for use by the user selection module 104 to determine if a given user has interesting unconsumed content available to him/her, and if the given user is likely to respond or interact with the campaign.

For example, the content sources 116 include one or more content databases 118 comprising content such as documents, links, meeting information, electronic communications information, etc. As another example, the content sources 116 include a search index 124, which is utilized to query various data sources to locate content items matching particular search strings. As another example, the content sources 116 include a graph index 120, which is utilized to retrieve data associated with relationships between a user and content items and relationships between the user and other individuals from a graph 120. According to an aspect, relationships between the user and content items and relationships between the user and other individuals are identified according to actions that the user performs in association with content items (e.g., authoring, modifying, liking, commenting, following, sharing, etc.), actions that the user performs in association with other individuals, actions that other individuals perform in association with the user, organizational relationships, and group memberships.

According to an aspect, the graph 120 is an abstract representation of nodes representing individuals, groups of individuals, and content items (e.g., documents, emails and other communication types, webpages, meeting objects, etc.), and edges connecting or defining relationships and activities between nodes. For example, relationship data and activity data is stored in the graph 120, wherein activities and relationships are stored as edges, and individuals interacted with and content items that are acted upon are stored as nodes. Relationship data and activity data are collected from a plurality of information sources, such as social networking services, enterprise social network services, productivity software application services, collaborative services, communication application services, etc. According to an aspect, relationships and activities in the graph 120 are scored and ranked. Scores are calculated according to factors such as organizational relationship type, frequency of interaction, recency of interaction, and type of interaction.

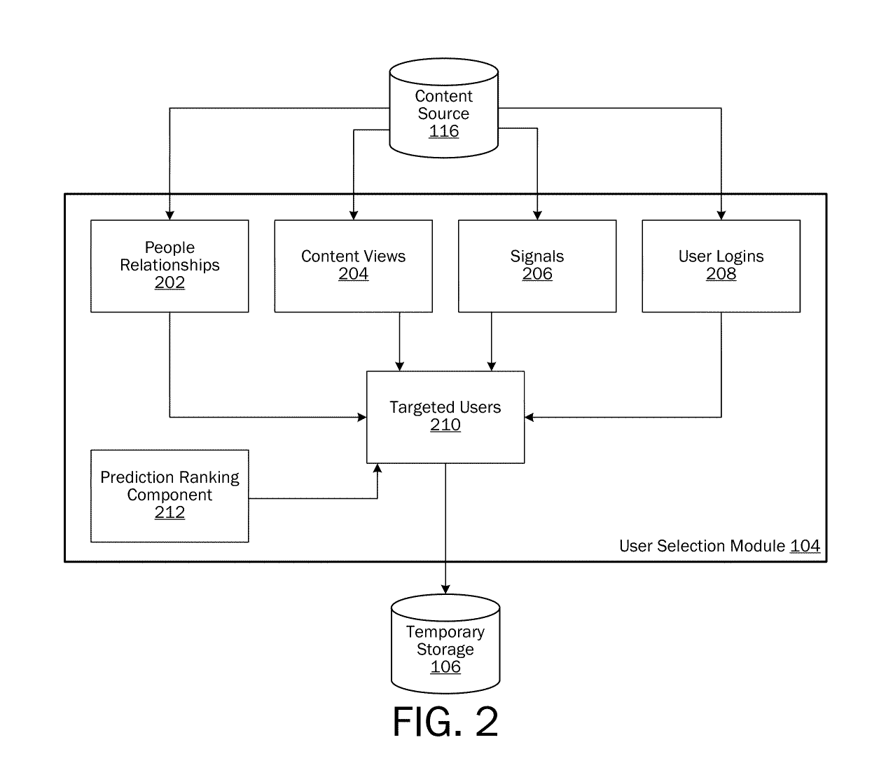

According to an aspect, the user selection module 104 generates a list of candidate users based on the last time the user interacted with or used the product associated with the campaign. According to another aspect, the user selection module 104 generates a list of candidate users based on the last time the user was targeted in a personalized campaign. According to an aspect, the user selection module 104 generates a list of candidate users based on the last time the user engaged with other related products. According to an aspect, the user selection module 104 generates a list of candidate users based on the amount of activity available to construct a campaign message (e.g., the activity of the user's closest peers, activity on the user's content, activity on a topic of the user's interest, etc.). According to an aspect, the user selection module 104 generates a list of candidate users based on a prediction rank of the likelihood of the user to respond or interact with the campaign. The user selection module 104 stores the list of candidate users in a temporary storage 106. The determination of a list of targeted users via the user selection module 104 will be described in further detail with respect to FIG. 2.

As illustrated, the personalized campaign system 100 includes a campaign construction module 108 operable to determine, for each targeted user, a campaign type and what content to include in the campaign message. According to an aspect, the campaign construction module 108 selects a campaign category and a template from an available list of campaign templates. For example, a campaign category and template are selected for a given user based on the user's activity and other properties and based on which templates have been previously sent to the user. Consider, for example, that the campaign construction module 108 selects a template for a first user that includes a subject line such as “[Colleague 1 name], [Colleague 2 name], and [Colleague 3 name] have updates for you,” and includes content such as documents that the user's colleagues are authoring, editing, commenting on, etc., and meetings that the user and his colleagues have attending and are scheduled to attend, etc.; and for a second user, the campaign construction module 108 selects a template that includes a subject line such as “Weekly activity on your feed,” and includes content that the second user has been acting on (e.g., authoring, editing, commenting on, sharing, etc.) over the previous week.

Campaign categories and templates vary, for example, by campaign message subject line, amount of information provided in a campaign message, type of information provided, frequency of campaign messages, and ratio of image versus text in a campaign message. According to an aspect, the campaign construction module 108 selects a campaign category and template for a given user based on a categorization of the user. Campaign goals vary depending on if the user is categorized as an active user, a super user, or a new user. For example, if a user is categorized as a super user who already actively uses the product, the user will less likely be targeted on a continuous basis. As another example, if a user is categorized as a new user, the goal for the campaign to the new user will be to bring the user up to speed on how the product works. Accordingly, the campaign message will include such information as tool tips. Additionally, the user will more likely be targeted on a more frequent basis. According to another aspect, the campaign construction module 108 selects a campaign category and template for a given user based on an industry in which the user works. According to another aspect, the campaign construction module 108 selects a campaign category and template for a given user based on the type of social influence the user has within his company.

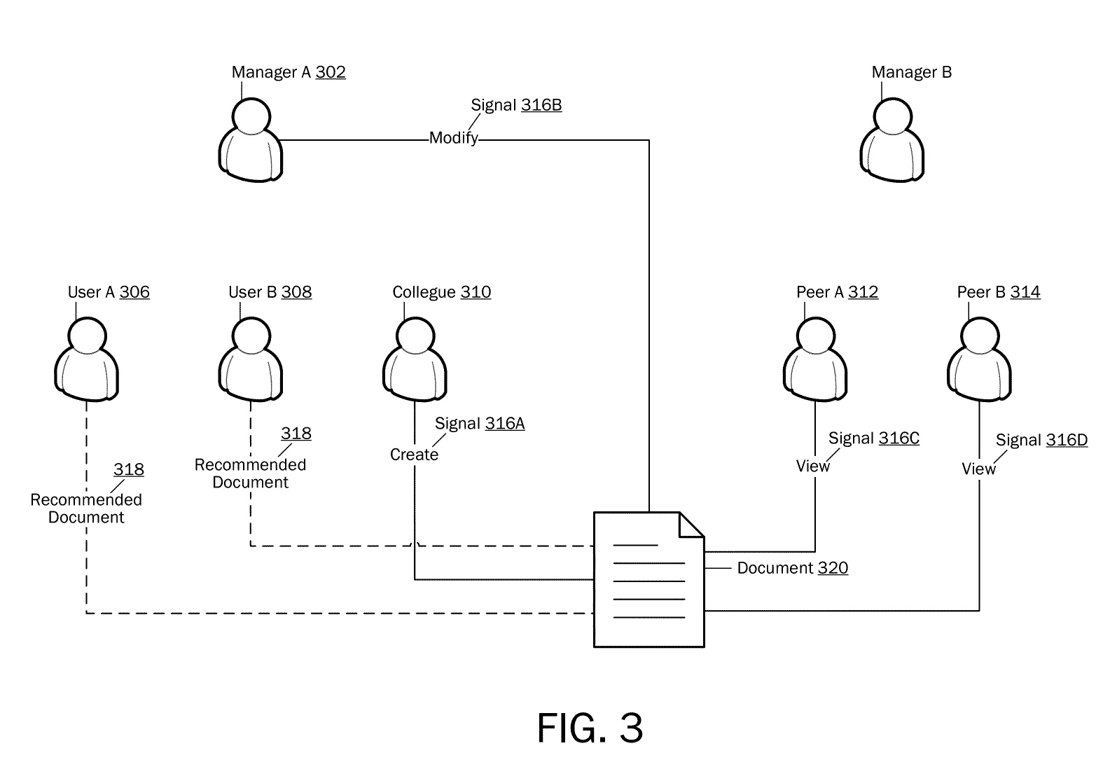

According to an aspect, the campaign construction module 108 queries the content source(s) 116, and selects content to include in a targeted user's campaign message based on what content items are currently trending around the user that have new activity over the last N days. According to another aspect, the campaign construction module 108 selects content to include in a targeted user's campaign message based on what content items are currently trending around the user's colleagues that have new activity over the last N days. The campaign construction module 108 identifies new activity on content items that are currently trending around the user and that are currently trending around the user's colleagues according to edges in the graph 120 created from the user's and the user's colleague's interactions with the content items. An example of how a content item is selected to become a piece of recommended content to be included in a campaign is illustrated in FIG. 3 and described below with reference to FIG. 3.

According to an aspect, the campaign construction module 108 is operable to construct a campaign message from a selected template for delivery and display to a targeted user via a selected medium (e.g., email, SMS, MMS, toast notification, social network message, audiovisual message, etc.). The campaign construction module 108 is operable to provide a display of the content items selected to be included in the campaign. According to an aspect, the campaign construction module 108 retrieves a content item preview image for each content item selected to be included in the campaign message. According to another aspect, the campaign construction module 108 retrieves information about the relationship between the user and each content item selected to be included in the campaign message (e.g., information associated with why the content item was selected for inclusion in the message). For example, the campaign construction module 108 retrieves buzz information (e.g., likes, comments, views, etc.) associated with each content item. According to an aspect, the campaign construction module 108 retrieves the content item preview image and relationship information from the one or more content sources 116.

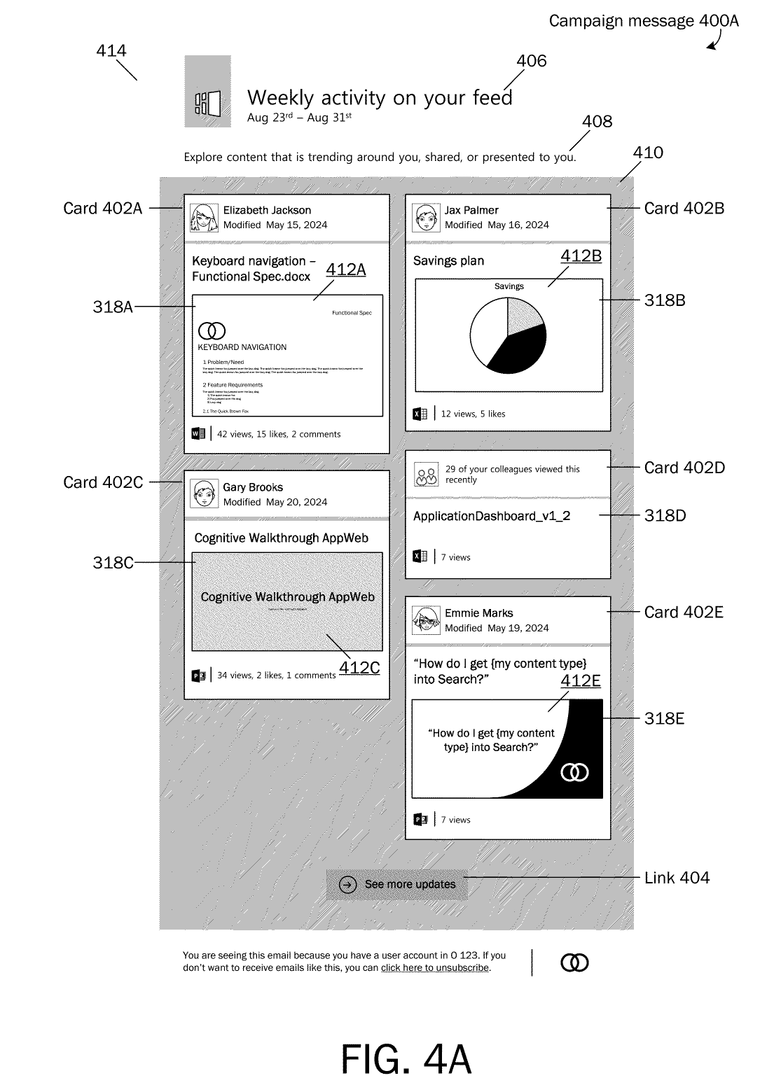

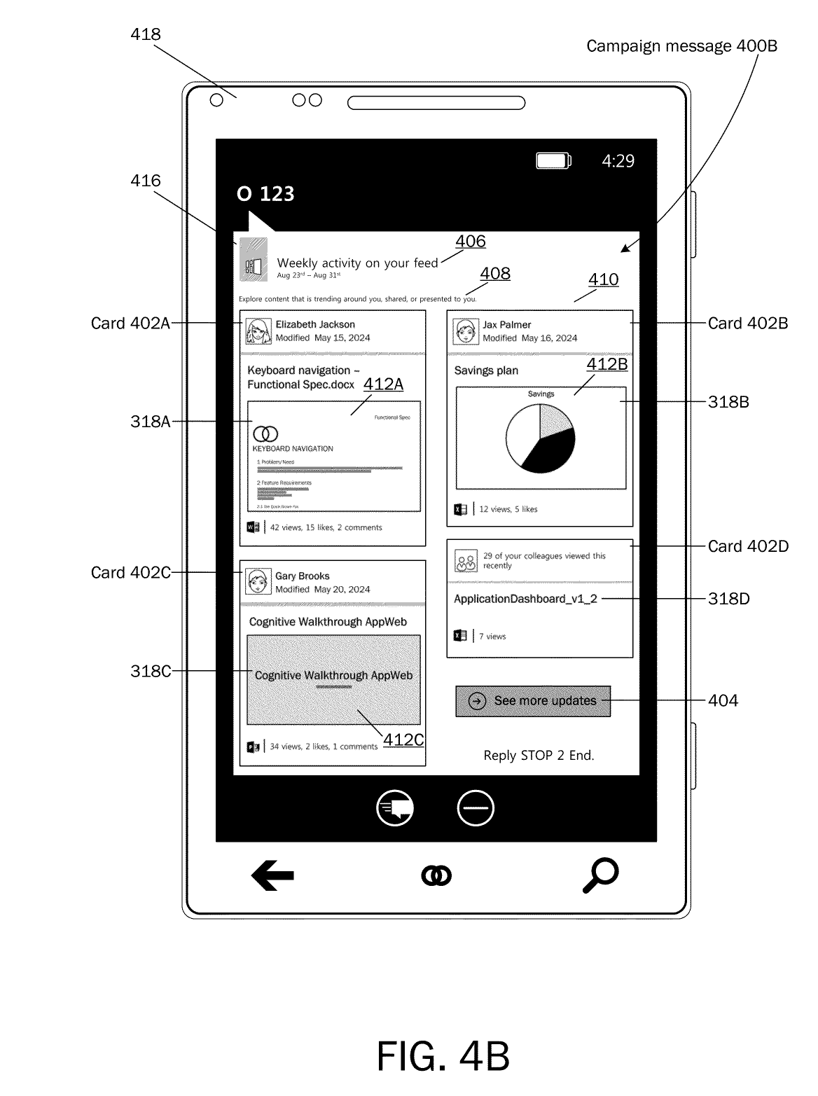

The campaign construction module 108 constructs the campaign message using the content item preview images and/or the information about the relationships between the user and the content items. For example, and as will be described below in greater detail with reference to FIGS. 4A and 4B, the campaign construction module 108 is operable to construct a campaign message wherein the content items selected to be included in the campaign message are displayed as content cards comprising one or more of: a header, a title, a preview image of the content item, and information associated with why the content item is relevant to the user. According to an aspect, the campaign construction module 108 is further operable to construct a campaign message comprising one or more selectable links, which when selected, provide access to a content item represented by a content card and/or to the product for which the campaign is featuring. For example, selection of a link provides access to a social product which discovers and surfaces relevant content to the user, and thus increases user efficiency by enabling the user to spend less time searching for content that he needs. The social product further enables the user to skip steps that he/she would normally go through to find relevant content for which he is searching.

Referring still to FIG. 1, the personalized campaign system 100 includes a campaign scheduler module 110. According to an aspect, the campaign scheduler module 110 is operable to determine a best medium (e.g., email, short message service (SMS) message, multimedia messaging service (MMS) message, toast notification, social network message, audiovisual message, etc.) for a campaign message based on the particular user and the particular campaign. According to an aspect, the medium is selected based on how the user interacted with previously sent campaign messages. For example, if a particular user received an email campaign message and interacted with the message (e.g., selected a link in the message to access the product), a signal is created and stored of the user's interaction with the campaign message.

According to another aspect, the campaign scheduler module 110 is operable to determine a best day of the week and best time of the day to deliver a campaign message to a particular user. According to an aspect, the campaign scheduler module 110 uses marketing research knowledge to determine a best day of the week and best time of the day to deliver a campaign message. For example, marketing research may indicate that users are more likely to open email after 12:00 pm, and the optimal time being between 2:00-5:00 pm. Marketing research may also indicate that the best days of the week are Monday to Friday, and the optimal time is between Tuesday and Thursday. Accordingly, the campaign scheduler module 110 schedules delivery of a particular campaign message for a weekday during normal working hours.

According to another aspect, the campaign scheduler module 110 uses user-specific data to determine a best day of the week and best time of the day to deliver a campaign message to a particular user. For example, the campaign scheduler module 110 determines a best combination of day of the week and time of the day for a particular user to receive a campaign message based on one or more of: the user's interactions with previously sent campaign messages; a pre-defined time frame that yields the best results in terms of click-through conversation; the user's location and time zone; the user's working schedule; the user's meeting schedule; and the user's personal schedule.

Upon determining a best delivery strategy for a particular campaign, the campaign message is stored in a campaign messages queue 114. According to an aspect, the campaign messages queue 114 comprises a list of users, campaign messages, campaign message mediums, and delivery schedules. The personalized campaign system 100 further comprises a campaign dispatcher module 112, operable to dispatch campaign messages according to the previously selected schedule and medium.

With reference now to FIG. 2, a simplified block diagram illustrating a process performed by the user selection module 104 for determining of a list of targeted users for a campaign. According to an aspect, the process illustrated in FIG. 2 runs continually. As described above, the user selection module 104 queries various content sources 116 for various criteria, which are used by the user selection module 104 to determine if a given user has unconsumed content available to him/her, and if the given user is likely to respond or interact with the campaign. According to an aspect, the user selection module 104 queries the content source(s) 116 for people relationships 202. For example, the user selection module 104 queries the graph index 122 for who a particular user is connected to in the graph 120. According to an aspect, a user is connected to another user in the graph 120 if there is an organizational relationship between the user and the other user. According to another aspect, a user is connected to another user in the graph 120 if there is activity between the user and the other user (e.g., communication, meeting attendance, on a same distribution list, etc.).

According to another aspect, the user selection module 104 queries the content source(s) 116 for content views 204. For example, the user selection module 104 queries the graph index 122 for which content items that are trending around the user (e.g., which content items are being viewed by the user's colleagues, which content items are being modified by the user's colleagues, which content items are being shared by the user's colleagues, which content items are being commented on by the user's colleagues, etc.).

According to another aspect, the user selection module 104 queries the content source(s) 116 for signals 206 associated with the user. According to an aspect, signals 206 are stored in a signal store. Signals include interactions between the user and another entity in the graph 120, for example, creation of a content item, modification of a content item, viewing of a content item, commenting on a content item, sharing of a content item, etc.

According to another aspect, the user selection module 104 queries the content source(s) 116 for user login data 208, for example, a last time the user logged in, how many times the user has logged in within a given time period, etc.

The user selection module 104 uses the people relationship data 202, the content views data 204, the signals data 206, and the login data 208 to determine users who have potentially interesting and unconsumed content which can be presented to the user in a campaign message, referred to as targeted users 210. According to an aspect, the user selection module 104 uses a prediction ranking component 212 to assign prediction rankings of the likelihood of the targeted users 210 to respond or interact with the campaign based on the gathered data 202, 204, 206, 208. A list of targeted users 210 is stored in a temporary storage 106.

With reference now to FIG. 3, an illustration of an example process of how a document 320 (i.e., content item) is selected to become a piece of recommended content 318 to be included in a campaign. As illustrated in FIG. 3, various signals 316A-D (collectively 316) occur between the document 320 and various individuals who share an organizational relationship with User A 306 and User B 308. For example, when Colleague 310 creates the document 320, a create signal 316A is established between the Colleague 310 and the document 320. Additionally, Manager A 302 modifies the document 320, and thus, a modify signal 316B is established between Manager A 302 and the document 320. Peer A 312 and Peer B 314 both view the document 320, and view signals 316C,D are established between Peers A 312 and B 314 and the document 320. Accordingly, the campaign construction module 108 determines that the document 320 is relevant to User A 306 and to User B 308 because of the interactions (e.g., create, modify, view) with the document 320, represented as signals 316, of the individuals with whom User A 306 and to User B 308 share a relationship. As illustrated, a new edge (i.e., recommended content 318) is generated between User A 306 and the document 320 and between user B 308 and the document 320. Thus, in generating campaigns for User A 306 and for User B 308, the document 320 will be included in the campaign messages.

Referring now to FIG. 4A, an example campaign message 400A is illustrated. In the illustrated example, the campaign message 400A is an email 414. As illustrated, the example campaign message 400A includes a subject line 406, which is selected by the campaign construction module 108. Additionally, the example campaign message 400A comprises text 408 and an image 410 of an activity feed for the targeted user 210. As mentioned above, in selecting a campaign category and template for the targeted user 210, the campaign construction module 108 selects a template having a certain text 408 to image 410 ratio. According to an aspect, recommended content items 318A-E (collectively 318) are displayed as content cards 402A-E (collectively 402). As illustrated, the content cards 402 comprise one or more of: a header, a title, a preview image 412A,B,C,E (collectively 412) of the recommended content item 318A-E, and information to help the targeted user 210 to understand why the recommended content item 318 would be interesting or relevant to him/her. For example, content card 402A includes information that Elizabeth Jackson (the user's colleague) modified the content item 318A and the date that the interaction took place. According to an aspect, the campaign message 400A comprises a selectable link 404 to access the product. For example, the selectable link 404 is a graphical user interface (GUI) button displayed in the campaign message 400A. As another example, the campaign message 400A is a selectable link 404 operable to access the product. According to another aspect, each content card 402 comprises one or more click/touch targets, which when selected, provide access to the recommended content item 318 the content card 402 represents. For example, one or more of the card header, the content item title, the content item preview image 412, and a buzz area (i.e., area where information about activity on the recommended content item 318 is displayed) comprise a click/touch target.

Referring now to FIG. 4B, an example campaign message 400B is shown displayed on a mobile computing device 418. In the illustrated example, the campaign message 400B is an MMS message 416. Like the example email campaign message 400A illustrated in FIG. 4A, the example MMS campaign message 400B illustrated in FIG. 4B includes a combination of text 408 and an image 410 of an activity feed for the targeted user 210 including a display recommended content items 318 represented as content cards 402. According to an aspect the MMS campaign message 400B comprises one or more click/touch targets, which when selected, provides access to the product or to the recommended content item 318 represented by the content card 402. The example campaign messages 400A,B are for purposes of example and illustration and are not limiting of other campaign message mediums, layouts, and features.

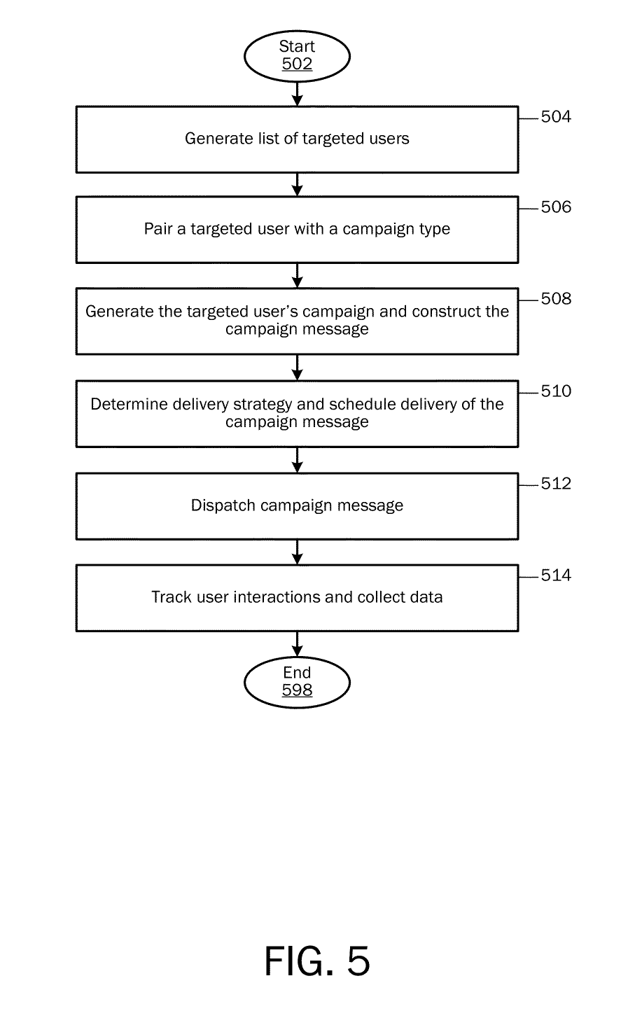

With reference now to FIG. 5, a flow chart of an example method 500 for providing a personalized and relevant campaign to a targeted user 210 is illustrated. The method 500 starts at OPERATION 502, and proceeds to OPERATION 504, where the user selection module 104 generates a list of targeted users 210, which are candidate receivers of a campaign message 400 to help expose the users 210 to a product, or to increase engagement of the users 210 with the product. As described above, the user selection module 104 queries various content sources 116 for various criteria, which are used by the user selection module 104 to determine if a given user has unconsumed content available to him/her, and if the given user is likely to respond or interact with the campaign. According to an aspect, the user selection module 104 uses people relationships data 202, content views data 204, signal data 206, and user login data 208 to determine if a user is a targeted user 210. According to an aspect, the user selection module 104 stores a list of target users 210 in temporary storage 106.

The method 500 proceeds to OPERATION 506, where a targeted user 210 is paired with a specific campaign type. For example, the campaign construction module 108 selects an appropriate campaign category and template, which subject line 406 to select, an amount of information to include, a ratio of image 410 versus text 408, etc., based on various criteria, such as one or more of: the targeted user's activity, based on which templates have been previously sent to the targeted user 210, a categorization of the user, in industry in which the user works, and the social influence the user has within his/her organization.

At OPERATION 508, the campaign construction module 108 determines which content items 318 to include in the campaign message 400, and constructs a campaign message 400 including information about the recommended content items 318 (e.g., a preview image 412 for each recommended content item 318 and information about the relation between the recommended content item 318 and the targeted user 210.

The method 500 proceeds to OPERATION 510, where the campaign scheduler module 110 determines a delivery strategy for and schedules delivery of the campaign message 400. For example, the campaign scheduler module 110 uses marketing data or historical user interaction data to determine a medium (e.g., email 414, SMS message, MMS message 416, toast notification, social network message, audiovisual message, etc.) for the campaign message 400 and a best day of the week and best time of the day to deliver the message 400 to the targeted user 210. Once a delivery strategy is determined for the campaign, the campaign schedule module 110 queues the campaign message 400 in the campaign messages queue 114.

At OPERATION 512, the campaign dispatcher module 112 reads the campaign message 400 from the queue 114, and dispatches campaign message 400 according to the previously selected schedule and medium. The method 500 proceeds to OPERATION 514, where the personalized campaign engine 102 tracks the target user's user interaction with the campaign message 400. According to an aspect, the personalized campaign engine 102 intercepts the targeted user's clicks/touches in the message 400, tracks the action, and redirects the targeted user 210 to the expected destination. For example, the personalized campaign engine 102 is operable to track when the targeted user 210 interacts with the campaign message 400, where the user clicked/touched, the medium type, template versions, etc. According to an aspect, the user interaction data is stored for determining future campaign strategies for the targeted user 210. The method 500 ends at OPERATION 598.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which aspects of the invention are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

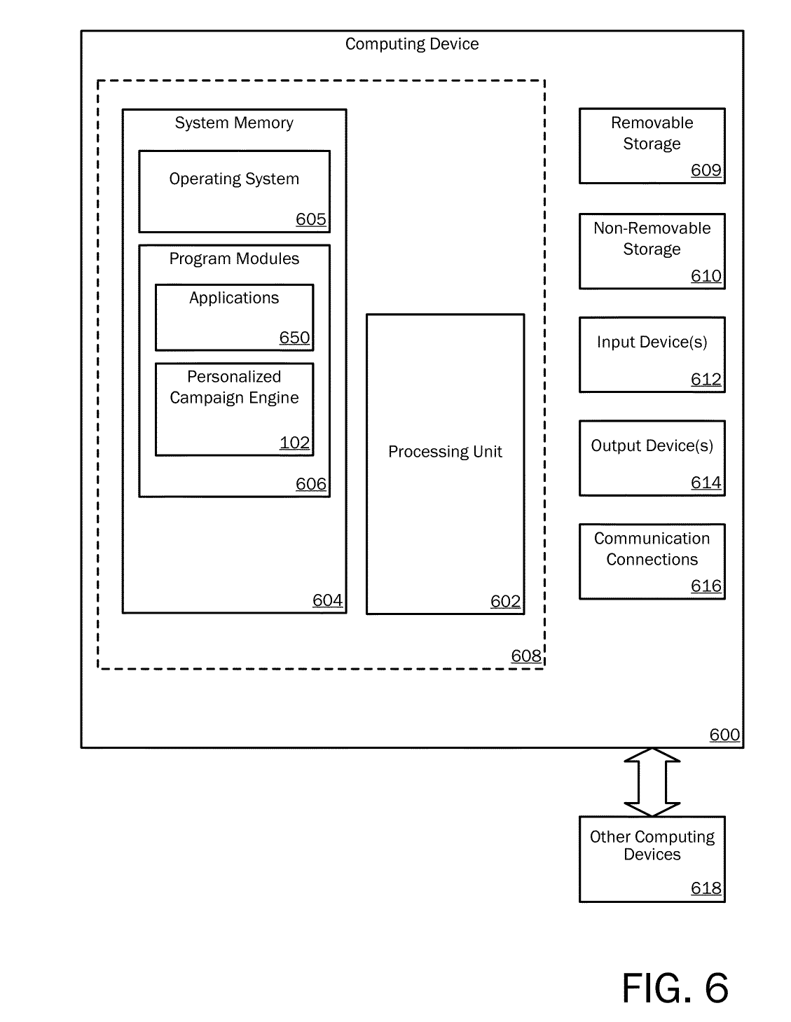

FIG. 6-8 and the associated descriptions provide a discussion of a variety of operating environments in which examples of the invention are practiced. However, the devices and systems illustrated and discussed with respect to FIGS. 6-8 are for purposes of example and illustration and are not limiting of a vast number of computing device configurations that are utilized for practicing aspects of the invention, described herein.

FIG. 6 is a block diagram illustrating physical components (i.e., hardware) of a computing device 600 with which examples of the present disclosure are be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more programming modules 606 suitable for running software applications 650. According to an aspect, the system memory 604 includes the personalized campaign engine 102. The operating system 605, for example, is suitable for controlling the operation of the computing device 600. Furthermore, aspects of the invention are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., personalized campaign engine 102) performs processes including, but not limited to, one or more of the stages of the method 500 illustrated in FIG. 5. According to an aspect, other program modules are used in accordance with examples of the present invention and include applications such as electronic mail and contacts applications, word processing applications, spreadsheet applications, database applications, slide presentation applications, drawing or computer-aided application programs, etc.

According to an aspect, aspects of the invention are practiced in an electrical circuit comprising discrete electronic elements, packaged or integrated electronic chips containing logic gates, a circuit utilizing a microprocessor, or on a single chip containing electronic elements or microprocessors. For example, aspects of the invention are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects of the invention are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

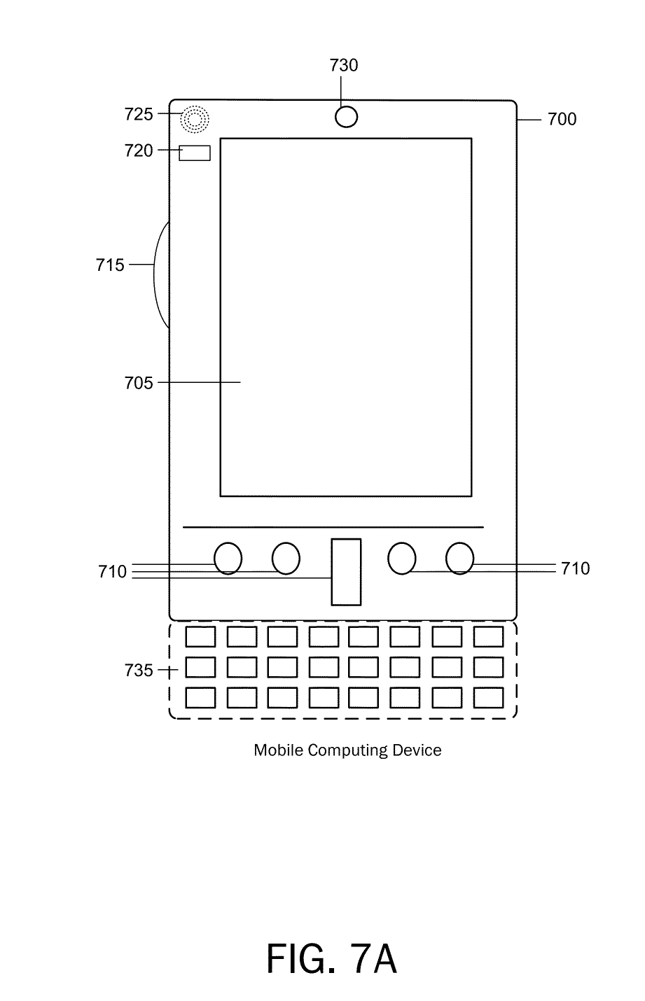

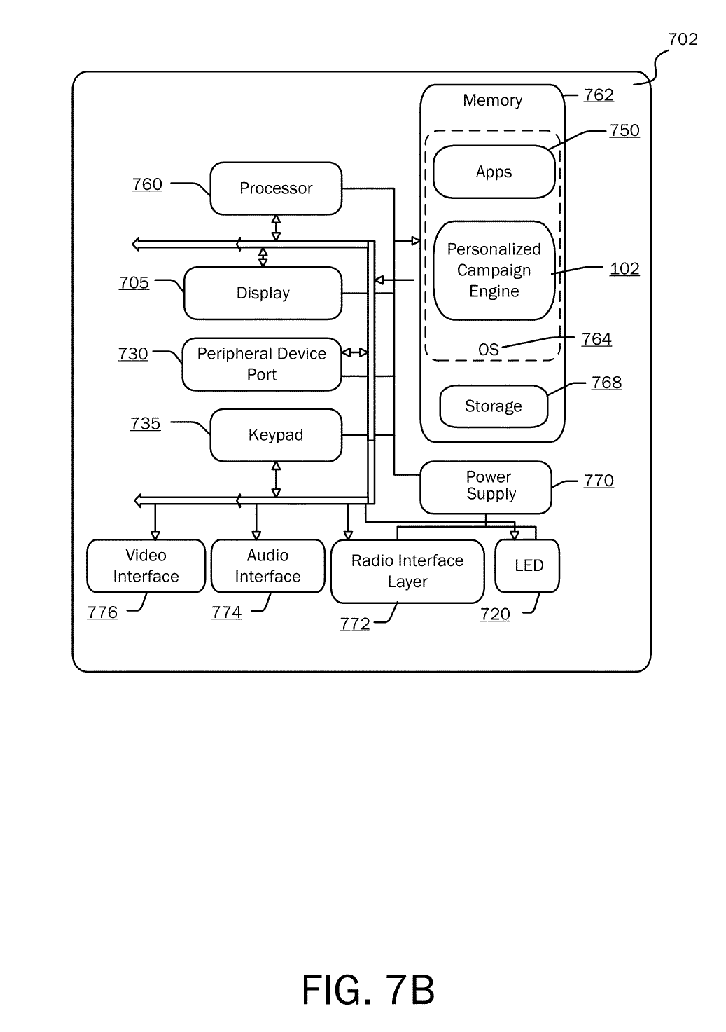

FIGS. 7A and 7B illustrate a mobile computing device 700, for example, a mobile telephone, a smart phone, a tablet personal computer, a laptop computer, and the like, with which aspects of the invention may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or less input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the personalized campaign engine 102 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

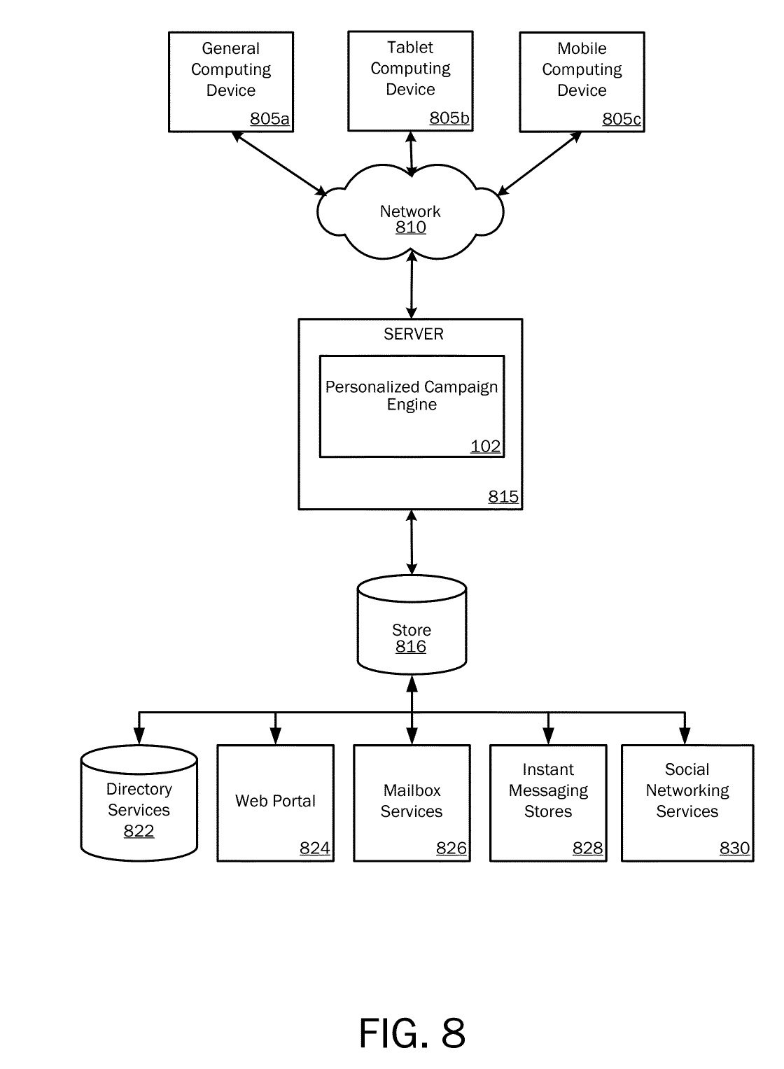

FIG. 8 illustrates one example of the architecture of a system for providing a personalized and relevant campaign to a targeted user 210 as described above. Content developed, interacted with, or edited in association with the personalized campaign engine 102 is enabled to be stored in different communication channels or other storage types. For example, various documents may be stored using a directory service 822, a web portal 824, a mailbox service 826, an instant messaging store 828, or a social networking site 830. The personalized campaign engine 102 is operable to use any of these types of systems or the like for providing a personalized and relevant campaign, as described herein. According to an aspect, a server 815 provides the personalized campaign engine 102 to clients 805A,B,C. As one example, the server 815 is a web server providing the personalized campaign engine 102 over the web. The server 815 provides the personalized campaign engine 102 over the web to clients 805 through a network 810. By way of example, the client computing device is implemented and embodied in a personal computer 805A, a tablet computing device 805B or a mobile computing device 805C (e.g., a smart phone), or other computing device. Any of these examples of the client computing device are operable to obtain content from the store 816.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A computer-implemented method for discovering and surfacing relevant content in a personalized campaign to a targeted user, comprising:
querying, by a computer, one or more content sources for activity data associated with a user and activity data associated with individuals with whom the user shares a relationship;
determining, by the computer, whether there is interesting unconsumed content available to the user based on the activity data associated with the user and the activity data associated with individuals with whom the user shares a relationship;
responsive to a positive determination that there is interesting unconsumed content available to the user, selecting, by the computer, a campaign template from a list of campaign templates;
constructing, by the computer, a campaign message from the selected campaign template;
selecting, by the computer, one or more interesting unconsumed content items to provide to the user based at least in part on the activity data associated with the user and the activity data associated with individuals with whom the user shares a relationship;
determining, by the computer, a delivery strategy for the campaign message;
scheduling, by the computer, delivery of the campaign message; and
providing, by the computer, the campaign message to the user, wherein the campaign message comprises one or more selectable links that provide access to a product associated with the campaign.

2. The computer-implemented method of claim 1, wherein querying one or more content sources for activity data associated with a user comprises querying a graph for content items that are trending around the user.

3. The computer-implemented method of claim 1, querying one or more content sources for activity data associated with individuals with whom the user shares a relationship comprises querying a graph for content items that are trending around individuals with whom the user shares a relationship.

4. The computer-implemented method of claim 1, wherein determining whether there is interesting unconsumed content available to the user comprises querying the one or more content sources for at least one of:
activity on the user's content;
activity on content by individuals with whom the user shares a relationship; and
activity on content of a topic of interest to the user.

5. The computer-implemented method of claim 4, wherein activity on content comprises at least one of:
creation of a content item;
modification of a content item;
viewing of a content item;
commenting on a content item; and
sharing of a content item.

6. The computer-implemented method of claim 5, further comprising determining, by the computer, a prediction rank of a likelihood of the user to interact with the campaign message, wherein the prediction rank is based on at least one of:
a last time the user interacted with the product associated with the campaign;
a last time the user was a target in a relevant campaign; and
a last time the user engaged with other related products.

7. The computer-implemented method of claim 1, wherein selecting a campaign template from a list of campaign templates comprises selecting a campaign template based on at least one of:
previous campaigns used with the user;
categorization of the user with the product associated with the campaign;
an industry in which the user works; and
social influence the user has within the user's company.

8. The computer-implemented method of claim 1, wherein constructing a campaign message comprises:
retrieving a content item preview image from the one or more content sources for each of the one or more interesting unconsumed content items selected to provide to the user;
retrieving relationship information between the user and each of the one or more interesting unconsumed content items from the one or more content sources; and
generating a content card for each of the one or more interesting unconsumed content items selected to provide to the user, wherein each content card is a representation of a content item and includes one or more of:
the content item preview image;
a description of the relationship between the user and the interesting unconsumed content item; and
a selectable link that provides access to the interesting unconsumed content items.

9. The computer-implemented method of claim 1, wherein selecting one or more interesting unconsumed content items to provide to the user comprises selecting one or more interesting unconsumed content items that are:
currently trending around the user that have new activity over a predetermined time period; or
currently trending around individuals with whom the user shares a relationship that have new activity over a predetermined time period.

10. The computer-implemented method of claim 1, wherein determining a delivery strategy for the campaign message comprises:
selecting a medium to provide the campaign message, wherein a medium comprises one of:
an email message;
a short messaging service message;
a multimedia messaging service message;
a toast notification;
a social network message; and
an audiovisual message; and
selecting a best day of the week and time of the day to deliver the campaign message.

11. A system for discovering and surfacing relevant content in a personalized campaign to a targeted user, the system comprising:
one or more processors;
memory storing one or more modules that are executable by the one or more processors, the one or more modules comprising:
a user selection module to:
query one or more content sources for activity data associated with a user and activity data associated with individuals with whom the user shares a relationship; and
determine whether there is interesting unconsumed content available to the user based on the activity data associated with the user and the activity data associated with individuals with whom the user shares a relationship;
a campaign construction module to:
in response to a positive determination that there is interesting unconsumed content available to the user, select a campaign template from a list of campaign templates;
construct a campaign message from the selected campaign template; and
select one or more interesting unconsumed content items to provide to the user based at least in part on the activity data associated with the user and the activity data associated with individuals with whom the user shares a relationship;
a campaign scheduler module to:
determine a delivery strategy for the campaign message; and
schedule delivery of the campaign message; and
a campaign dispatcher module to provide the campaign message to the user, wherein the campaign message comprises one or more selectable links that provide access to a product associated with the campaign.

12. The system of claim 11, wherein in querying one or more content sources for activity data associated with a user, the user selection module is operable to query a graph for content items that are trending around the user.

13. The system of claim 11, wherein in querying one or more content sources for activity data associated with individuals with whom the user shares a relationship, the user selection module is operable to query a graph for content items that are trending around individuals with whom the user shares a relationship.

14. The system of claim 11, wherein in determining whether there is interesting unconsumed content available to the user, the user selection module is operable to query the one or more content sources for at least one of:
activity on the user's content;
activity on content by individuals with whom the user shares a relationship; and
activity on content of a topic of interest to the user.

15. The system of claim 14, wherein in querying the one or more content sources for activity on content, the user selection module is operable to query a graph for edges connecting the user and content items and edges connecting individuals with whom the user shares a relationship and content items, wherein the edges represent an interaction with the content items.

16. The system of claim 15, wherein interaction with the content items comprise at least one of:
creation of a content item;
modification of a content item;
viewing of a content item;
commenting on a content item; and
sharing of a content item.

17. The system of claim 11, wherein in constructing a campaign message, the campaign construction module is operable to:
retrieve a content item preview image from the one or more content sources for each of the one or more interesting unconsumed content items selected to provide to the user;
retrieve relationship information between the user and each of the one or more interesting unconsumed content items from the one or more content sources; and
generate a content card for each of the one or more interesting unconsumed content items selected to provide to the user, wherein each content card is a representation of a content item and includes one or more of:
the content item preview image;
a description of the relationship between the user and the interesting unconsumed content item; and
a selectable link that provides access to the interesting unconsumed content items.

18. The system of claim 11, wherein in selecting one or more interesting unconsumed content items to provide to the user, the campaign construction module is operable to select one or more interesting unconsumed content items that are:
currently trending around the user that have new activity over a predetermined time period; or
currently trending around individuals with whom the user shares a relationship that have new activity over a predetermined time period.

19. One or more computer storage media storing computer-useable instructions that, when used by one or more computing devices, cause the one or more computing devices to perform a method for discovering and surfacing relevant content in a personalized campaign to a targeted user, the method comprising:
querying one or more content sources for activity data associated with a user and activity data associated with individuals with whom the user shares a relationship;
determining, by the computer, whether there is interesting unconsumed content available to the user based on the activity data associated with the user and the activity data associated with individuals with whom the user shares a relationship;
responsive to a positive determination that there is interesting unconsumed content available to the user, selecting, by the computer, a campaign template from a list of campaign templates;
constructing, by the computer, a campaign message from the selected campaign template;
selecting, by the computer, one or more interesting unconsumed content items to provide to the user based at least in part on the activity data associated with the user and the activity data associated with individuals with whom the user shares a relationship;
determining, by the computer, a delivery strategy for the campaign message;
scheduling, by the computer, delivery of the campaign message; and
providing, by the computer, the campaign message to the user, wherein the campaign message comprises one or more selectable links that provide access to a product associated with the campaign.

20. The one or more computer storage media of claim 19, wherein constructing a campaign message comprises:
retrieving a content item preview image from the one or more content sources for each of the one or more interesting unconsumed content items selected to provide to the user;
retrieving relationship information between the user and each of the one or more interesting unconsumed content items from the one or more content sources; and
generating a content card for each of the one or more interesting unconsumed content items selected to provide to the user, wherein each content card is a representation of a content item and includes one or more of:
the content item preview image;
a description of the relationship between the user and the interesting unconsumed content item; and
a selectable link that provides access to the interesting unconsumed content items.
